(19) United States
(12) Patent Application Publication
(10) Pub. No.: US 2018/0053384 A1
(43) Pub. Date: Feb. 22, 2018

(54) MOBILE DEVICE AND METHOD FOR GENERATING PERCEPTIBLE OUTPUT BASED ON A TEXTUAL CODE

(71) Applicant: Futurewei Technologies, Inc., Plano, TX (US)

(72) Inventor: Reza Yazdani, Los Altos, CA (US)

(21) Appl. No.: 15/242,397

(22) Filed: Aug. 19, 2016

(51) Int. Cl. G08B 5/22; H04W 52/02; G06F 3/01; G08B 3/10

(52) U.S. Cl. CPC G08B 5/224; G08B 3/1025; G06F 3/016; H04W 52/0296

(57) ABSTRACT

A mobile device apparatus and method are provided for generating perceptible output based on a textual code. Included is a mobile device with a processor in communication with a memory and a network interface. The mobile device is configured to receive a textual code, utilizing the network interface. Further, the mobile device is configured to determine whether the received textual code matches at least one stored textual code stored within the memory. Still yet, the mobile device is further configured to generate at least one perceptible output if the received textual code matches the at least one stored textual code.

### FIELD OF THE INVENTION

The present invention relates to communication systems, and more particularly to advanced mobile device functionalities.

### BACKGROUND

Current mobile devices and systems that support the same have a capability of locating a mobile device when lost. This is typically accomplished by the system receiving global positioning system (GPS) information (e.g. a device location, etc.) from the mobile device, and an owner of the mobile device logging into the system using a different device (e.g. a computer, another device, etc.), to view such GPS information. One challenge with such frameworks may involve a precision with which the location of the mobile device is provided. In some cases, the aforementioned GPS may not necessarily be accurate enough to be helpful (e.g. by only identifying a general area where the mobile device was last located, etc.).

### SUMMARY

A mobile device apparatus is provided for generating perceptible output based on a textual code. Included is a mobile device with a processor in communication with a memory and a network interface. The mobile device is configured to receive a textual code, utilizing the network interface. Further, the mobile device is configured to determine whether the received textual code matches at least one stored textual code stored within the memory. Still yet, the mobile device is further configured to generate at least one perceptible output if the received textual code matches the at least one stored textual code.

Also provided is a mobile device method for generating perceptible output based on a textual code. In use, a mobile device receives a textual code, and determines whether the received textual code matches at least one stored textual code stored within the mobile device. The mobile device further generates at least one perceptible output if the received textual code matches the least one stored textual code.

In a first embodiment, the at least one perceptible output may include a tactile output generated by a tactile output device of the mobile device.

In a second embodiment (which may or may not be combined with the first embodiment), the at least one perceptible output may include an audible output generated by an auditory output device of the mobile device.

In a third embodiment (which may or may not be combined with the first and/or second embodiments), the at least one perceptible output may include a visual output generated by a visual output device of the mobile device.

In a fourth embodiment (which may or may not be combined with the first, second, and/or third embodiments), the at least one perceptible output may include a message outputted by a network interface of the mobile device.

In a fifth embodiment (which may or may not be combined with the first, second, third, and/or fourth embodiments), the at least one stored textual code may be predefined by an owner of the mobile device.

In a sixth embodiment (which may or may not be combined with the first, second, third, fourth, and/or fifth embodiments), a file embodying the at least one perceptible output may be stored by the mobile device, for use in connection with the generation of the at least one perceptible output.

In a seventh embodiment (which may or may not be combined with the first, second, third, fourth, fifth, and/or sixth embodiments), user input may be detected, utilizing an input device. Further, the processor may be further configured to cease the at least one perceptible output in response to the detection of the user input.

In an eighth embodiment (which may or may not be combined with the first, second, third, fourth, fifth, sixth, and/or seventh embodiments), a power supply level of a power supply of the mobile device may be detected. Further, it may be determined whether the power supply level falls below a predetermined threshold. Further, use of the power supply may be allocated to at least one aspect of the generation of the at least one perceptible output, if the power supply level of the mobile device falls below the predetermined threshold.

In a ninth embodiment (which may or may not be combined with the first, second, third, fourth, fifth, sixth, seventh, and/or eighth embodiments), a power supply level of a power supply of the mobile device may be detected. Further, it may be determined whether the power supply level falls below a predetermined threshold. If the power supply level of the mobile device falls below the predetermined threshold, an auxiliary power source may be utilized for at least one aspect of the generation of the at least one perceptible output.

In a tenth embodiment (which may or may not be combined with the first, second, third, fourth, fifth, sixth, seventh, eighth, and/or ninth embodiments), a file embodying the at least one perceptible output may be received, utilizing the network interface of the mobile device. Further, the at least one perceptible output may be generated utilizing the file in response to the receipt of the file, if it is determined that the received textual code matches the stored at least one textual code.

In an eleventh embodiment (which may or may not be combined with the first, second, third, fourth, fifth, sixth, seventh, eighth, ninth, and/or tenth embodiments), the received textual code may be manually generated by a user of another device or may be automatically generated by an application installed on the another device.

To this end, in some optional embodiments, one or more of the foregoing features of the aforementioned apparatus, computer program and/or method may facilitate the return of a lost mobile device. Such features may be particularly helpful when conventional device locating systems exhibit insufficient locating precision. In such case, the mobile device may be more easily located by the owner by simply sending the mobile device the aforementioned textual code. Further, the present feature may have applications beyond identifying a location of the mobile device. For example, such textual codes may be sent among parties to prompt respective mobile devices to automatically exhibit various audible, tactile, and/or visual indications which may be used by such parties to conveniently communicate without necessarily relying on conventional types of messages (e.g. e-mail, text, phone call, voice message, etc.). This may, in turn, result in significant convenience and enhanced communication among parties that would otherwise be foregone in systems that lack such capabilities. It should be noted that the aforementioned potential advantages are set forth for illustrative purposes only and should not be construed as limiting in any manner.

### BRIEF DESCRIPTION OF THE DRAWINGS

FIG. 1 is a flowchart of a method for generating perceptible output based on a textual code, in accordance with one embodiment.

FIG. 2A is a flowchart of a method for enabling a code-sound capability, in accordance with another embodiment.

FIG. 2B is a flowchart of another method for generating perceptible output based on a textual code, in accordance with another embodiment.

FIG. 3 illustrates a registration interface, in accordance with one embodiment.

FIG. 4 illustrates a network architecture including various mobile devices, in accordance with one embodiment.

FIG. 5 illustrates an exemplary mobile device system, in accordance with one embodiment.

### DETAILED DESCRIPTION

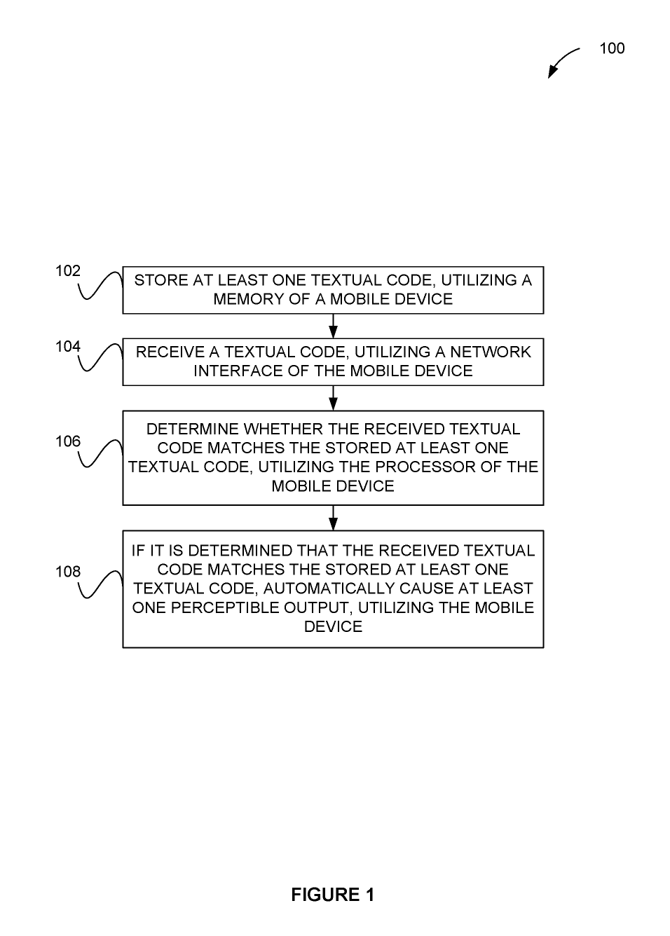

FIG. 1 is a flowchart of a method 100 for generating perceptible output based on a textual code, in accordance with one embodiment. The perceptible output comprises one or more of sound or sound signals, visual displays including displays of objects, symbols, or other representations, tactile sensations or signals, or olfactory sensations or signals. As shown, at least one textual code is stored in step 102, utilizing a memory of a mobile device. In the context of the present description, the textual code may include any combination of letter(s), number(s), and/or character(s) (e.g. @, #, $, etc.). For example, the textual code may include one or more letters in one embodiment, one or more numbers in another embodiment, one or more characters in yet another embodiment, and/or a combination of any of the above in still yet another embodiment. Further, in another optional embodiment, the stored textual code may be predefined by an owner of the mobile device. For example, such owner may either manually generate the code (e.g. by typing the same, etc.), and/or one or more proposed codes may be accepted by the owner, prior to being stored for reasons that will soon become apparent.

In step 104, a textual code is received by the mobile device, utilizing a network interface of the mobile device. In one embodiment, the textual code may be received utilizing a short message service (SMS) protocol or multimedia messaging service (MMS) protocol (or any other protocol, for that matter), via cellular and/or WiFi network interface, etc. Further, it should be noted that, in various embodiments, receipt of the textual code may be prompted by the mobile device, wherein the textual code is generated and transmitted by the sending device, either manually or automatically. Specifically, a manual prompt may involve a manual entry of the textual code by an operator, followed by selection of a send button, and/or manual selection of a shortcut that results in the textual code being sent. In other embodiments, the textual code may be sent in an automated manner as a result of a program or script that triggers upon certain criteria being met (e.g. time criteria, location criteria, flow-based criteria, etc.).

After receipt of the textual code, it is determined by the mobile device in step 106 whether the received textual code matches stored textual code(s), utilizing a processor of the mobile device. As an option, such determination may be accomplished by comparing the received textual code to the stored textual code, in response to the arrival of the textual code.

If it is determined that the received textual code matches the stored textual code, at least one perceptible output is automatically generated by the mobile device, in step 108. In one embodiment, the at least one perceptible output may be generated immediately after receipt of the textual code. In other embodiments, a delay may be incorporated before such output, based on one or more conditions (e.g. time condition, location condition, a manual “do not disturb” condition, etc.).

Further, the at least one perceptible output may be generated in any desired manner. For example, in various embodiments, the at least one perceptible output may be generated by generating or executing a command, invoking a separate application that administers the at least one perceptible output, sending a signal to an output device, etc. Still yet, it should be noted that the at least one perceptible output may be generated via an output device integrated with the mobile device (e.g. integrated speaker, etc.), and/or via an output device that is separate from the mobile device. (i.e. connected via hardwiring and/or a wireless connection, etc.). Non-limiting examples of such separate output device may include a separate stand-alone speaker, a separate stand-alone sound system, a separate stand-alone television, etc.

It should be noted that the at least one perceptible output may take any form that is perceptible to a human being. For example, in one embodiment, the at least one perceptible output may include a tactile output that is generated, utilizing a tactile output device (e.g. vibrator, etc.) of the mobile device. In another embodiment, the at least one perceptible output may include an audible output that is generated, utilizing an auditory output device (e.g. speaker, etc.) of the mobile device. In still another embodiment, the at least one perceptible output may include a visual output that is generated, utilizing a visual output device (e.g. screen, touchscreen, light source, etc.) of the mobile device. In even still yet another embodiment, the at least one perceptible output may include a message (e.g., an electronic message, optical message, or other message capable of being transmitted to another device, such as a text message, etc.) that is generated and then transmitted utilizing the network interface (e.g. modem, etc.) of the mobile device.

In one optional embodiment, the at least one perceptible output may include a single perceptible output. In other embodiments, the at least one perceptible output may include multiple perceptible outputs that may or may not be of a different type (e.g. audible, tactile, visual, etc.). Further, such multiple outputs may be components of a single output (e.g. song, story, theme, etc.) where such multiple outputs may be strung together continuously and/or intermittently. In an embodiment where multiple outputs are intermittently generated, such multiple outputs may be afforded in a predetermined manner (e.g. at certain intervals), or in a dynamic manner (e.g. based on one or more changing parameters/conditions, etc.).

To this end, in some optional embodiments, one or more of the foregoing features may facilitate the return of a lost mobile device. Such features may be particularly helpful when conventional device locating systems exhibit insufficient locating precision. In such case, the mobile device may be more easily located by the owner by simply sending to the mobile device the aforementioned textual code or codes. Further, the present feature may have applications beyond identifying a location of the mobile device. For example, such textual codes may be sent among parties to prompt respective mobile devices to automatically exhibit various audible, tactile, and/or visual indications which may be used by such parties to conveniently communicate without necessarily relying on conventional types of messages (e.g. e-mail, text, phone call, voice message, etc.). This may, in turn, result in significant convenience and enhanced communication among parties that would otherwise be foregone in systems that lack such capabilities. It should be noted that the aforementioned potential advantages are set forth for illustrative purposes only and should not be construed as limiting in any manner.

More illustrative information will now be set forth regarding various optional architectures and uses in which the foregoing method may or may not be implemented, per the desires of the user. For example, in various embodiments, the textual codes may prompt a static and/or dynamic perceptible output. Any of the following features may be optionally incorporated with or without the exclusion of other features described.

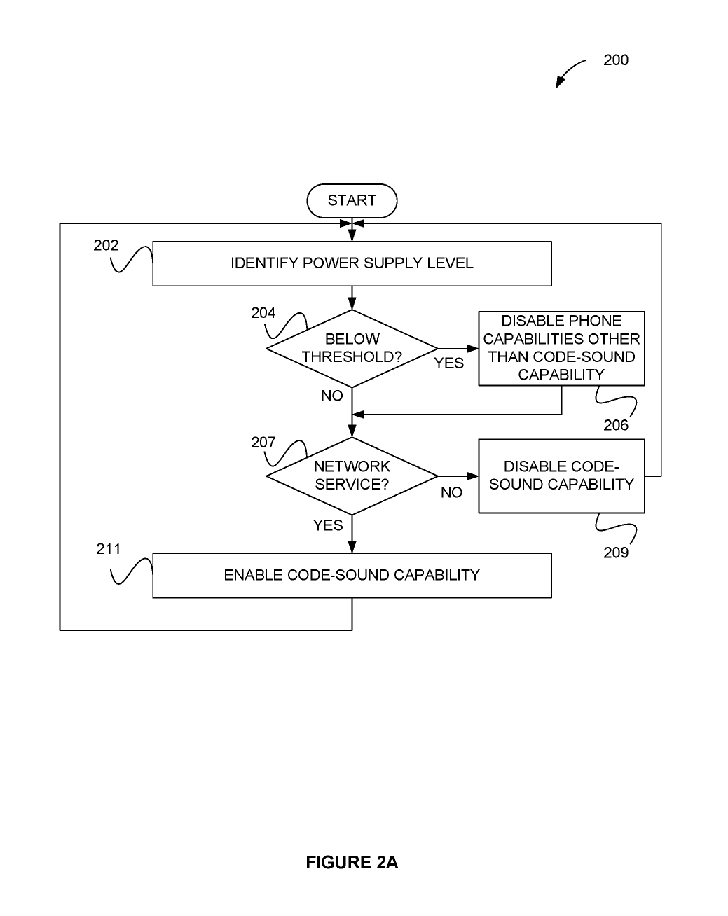

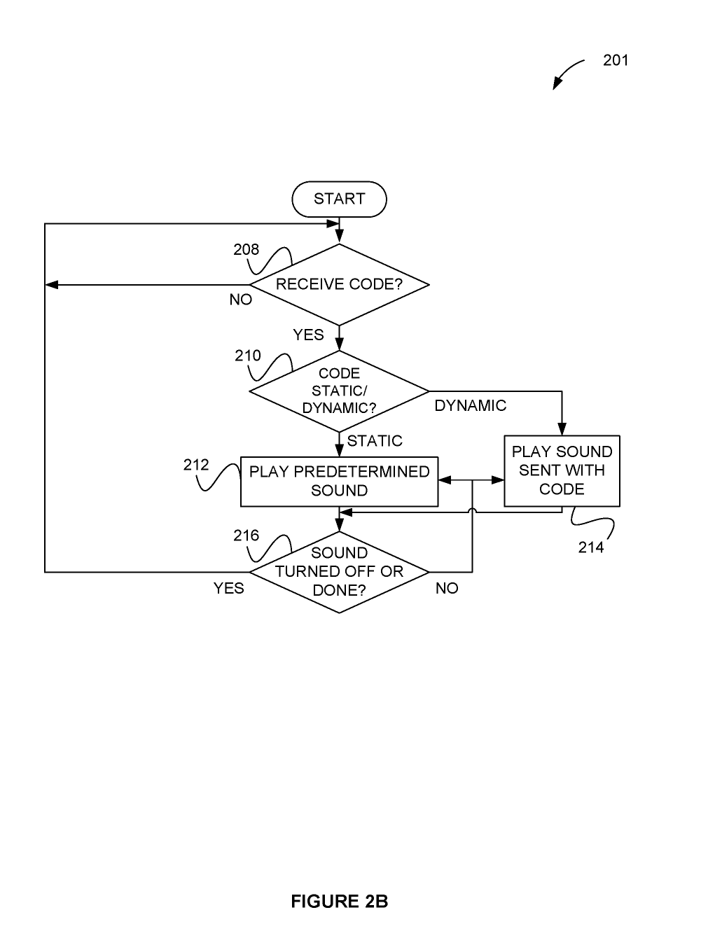

FIG. 2A is a flowchart of a method 200 for enabling a code-sound capability, in accordance with another embodiment. As an option, the method 200 may be implemented in the context of any one or more of the embodiments set forth in any previous and/or subsequent figure(s) and/or description thereof. For example, the method 200 may be implemented in the context of method 100 of FIG. 1. However, it is to be appreciated that the method 200 may be implemented in the context of any desired environment.

As shown, a power supply level of a power supply of the mobile device is detected at step 202. Further, it is determined in decision 204 whether the power supply level of the mobile device falls below a predetermined threshold. If it is determined that the power supply level of the mobile device falls below the predetermined threshold, use of the power supply may be restricted in step 206. Consequently, electrical power in some embodiments will be conserved, wherein power is instead allocated for determining whether a textual code has been received, and subsequently generating the at least one perceptible output (e.g. any aspect of one or more of the steps 102-108 of FIG. 1, etc.). As a further option, if it is determined that the power supply level of the mobile device falls below the predetermined threshold, an auxiliary power source may be utilized, wherein electrical power from the auxiliary power source is allocated partially or fully to at least one aspect of automatically generating the at least one perceptible output.

With continuing reference to FIG. 2A, the method 200 determines in decision 207 whether a network service (e.g. cellular, WiFi, etc. service, etc.) is available. If such service is not available, then in step 209 the code-sound capability is disabled and the method 200 returns to step 202. If, however, the service is available, then decision 207 proceeds to step 211 and the code-sound capability is enabled, whereupon the method 200 returns to step 202. It should be noted that any iteration of any of the steps of FIG. 2A may incorporate a predetermined or user-configured delay between each iteration to save battery power. More information will now be set forth regarding one possible method for providing a code-sound capability when such mode is enabled.

FIG. 2B is a flowchart of another method 201 for generating perceptible output based on a textual code, in accordance with another embodiment. As an option, the method 201 may be implemented in the context of any one or more of the embodiments set forth in any previous and/or subsequent figure(s) and/or description thereof. For example, the method 201 may be implemented in the context of method 100 of FIG. 1 and/or the method 200 of FIG. 2A. However, it is to be appreciated that the method 201 may be implemented in the context of any desired environment.

With reference to FIG. 2B, the method 201 polls until a textual code is received per decision 208. Upon receipt, it is first determined whether the code is static or dynamic in decision 210. In various embodiments, the code may exhibit one of multiple different predetermined formats, one allocated for static codes and one allocated for dynamic codes, so that the codes may be distinguished in decision 210. Static textual codes are fixed in meaning. Dynamic codes can be changed. For example, a person sending a dynamic code can choose or assign a meaning. In other embodiments, a predetermined character of the code (e.g. first, last, etc.) may be allocated to distinguish between static and dynamic codes. In still other embodiments, a single predetermined code may be allocated to designate a dynamic code. It should be noted, however, that the static and dynamic codes may be distinguished in any desired manner.

If the code is determined to be a static code, per decision 210, a predetermined sound is emitted in step 212. To accomplish this in accordance with one embodiment, a sound file embodying the at least one perceptible output may be previously stored in the mobile device, utilizing the memory of the mobile device. Such file may be of any desired coding format [e.g. Waveform Audio File Format (WAVE), Windows Media Audio (WMA), MP3, etc.] that may or may not be compressed. To this end, upon receipt of a static code that matches the code stored in connection with the audio file, the audio file may be automatically played. In one possible embodiment, in addition to being remotely activated via the aforementioned code(s), the sound may also be prompted locally (e.g. by selecting an associated icon, manipulating a mechanical switch, etc.).

While an embodiment is contemplated where only a single sound is capable of being emitted in response to a single static code, other embodiments are contemplated where multiple static codes and corresponding sounds exist. In such embodiment, a plurality of textual codes may be stored, utilizing the memory of the mobile device. Table 1 illustrates an exemplary data structure including the multiple textual codes and corresponding sounds/outputs.

TABLE 1

| | |
|---|---|
| Textual_Code_1 | Static Sound_1 |
| Textual_Code_2 | Static Sound_2 |
| Textual_Code_3 | Static Sound_3 |
| Textual_Code_4 | Static Sound_4_Part 1, Sound_4_Part 2, |
| | Sound_4_Part 3 |
| Textual_Code_5 | Static Tactile Output_1 |
| Textual_Code_6 | Static Tactile Output_2 + Sound_1 + |
| | Display_Image_1 |
| Textual_Code_7 | Dynamic Code_1 |
| Textual_Code_8 | Initiate Return Phone Mode |
| Textual_Code_9 | Dynamic Code_2 |

Thus, in the present embodiment, it may be determined whether the textual code received per decision 208 matches at least one of the stored textual codes (like those shown in Table 1), utilizing the processor of the mobile device. If it is determined that the received textual code matches at least one of the stored textual codes, at least one of a plurality of perceptible outputs may be selected, based on the determination. Per step 212, the selected at least one perceptible output may be automatically generated, utilizing the mobile device.

Returning to decision 210, if it is determined that the received textual code matches the stored textual code designated as a dynamic code (e.g. Textual_Code_7 and Textual_Code_9 of Table 1, etc.), the method 201 may be configured to expect the receipt of a file embodying the at least one perceptible output, sent by the sender with the dynamic code, utilizing the network interface of the mobile device. Further, in response to the receipt of the file embodying the at least one perceptible output, the at least one perceptible output may be automatically generated, utilizing the file embodying the at least one perceptible output in step 214, if it is determined that the received textual code matches the stored textual code designated as a dynamic code.

For a dynamic textual code, when the file has been completely received (or sufficiently received to begin playback), the file may be executed to commence playback of the sound. In other embodiments, any received sound file may be saved and may be played at will, as well as removed manually or automatically. As a further option, the dynamic code may cause a sound to play, as well as initiate an application (and associated functionality) at the same time.

Strictly as an option, one or more of the textual codes (e.g. Textual_Code_8 of Table 1, etc.) may be reserved to initiate a return phone mode. More information regarding one possible return phone mode of operation which may incorporate any one or more features disclosed herein is set forth in an application filed coincidently herewith under Attorney Docket Number 85062293US01/FUWEP041 and entitled “APPARATUS, COMPUTER PROGRAM, AND METHOD FOR FACILITATING A RETURN OF A MOBILE DEVICE TO AN OWNER,” which is incorporated herein by reference in its entirety for all purposes.

As a further option, various operating system-type features may be automatically enabled and/or disabled to accommodate the playback of the sound. For example, if other sound (e.g. music, etc.) is currently being played, such other sound may be paused while the static/dynamic sound is emitted. Further, a mute option may be disabled so that the static/dynamic sound may be emitted. Still yet, in the case of visual display output, a sound may precede/accompany the visual display output to obtain the user's attention. Even still, facial recognition may be employed to ensure that the user is viewing the phone before showing (or ceasing to show) the visual display output.

In still other optional embodiments, the receipt of the textual code may serve to initiate the emission of sound, but other factors (e.g. time, location, movement, ambient noise, etc.) may be used to adjust/select the particular sound to be emitted. For example, the same single code may prompt the emission of a first sound when the mobile device is at home, and further prompt the emission of a second sound when the mobile device is outside the home. Further, in an embodiment where the sound is a person speaking, such script may be delivered in a language that is selected based on a location of the mobile device. Even still, in an embodiment where the mobile device can detect certain levels of ambient noise (e.g. via a microphone, etc.), a volume of the sound may be adjusted (up or down) based on a level of such ambient noise.

With continuing reference to FIG. 2B, the sound may be emitted until the sound is turned off or simply complete per decision 216. In various embodiments, the at least one perceptible output may be continued for a predetermined amount of time, and may be ceased either manually and/or automatically. For example, in one embodiment, user input may be detected, utilizing an input device of the mobile device. In response to the detection of the user input, the at least one perceptible output may be ceased. For instance, a “stop” icon and/or password entry interface may be displayed in connection with the emission of the sound, allowing the user to stop the sound if desired. In other embodiments, the sound may simply stop at an endpoint (of a song or portion thereof), or after a predetermined amount of time (e.g. 10, 20, 30 seconds, etc.). It should be noted that, while the foregoing embodiments involve an audible perceptible output (e.g. a sound, etc.), other embodiments are contemplated where other types of perceptible outputs are contemplated (e.g. visual, tactile, etc.).

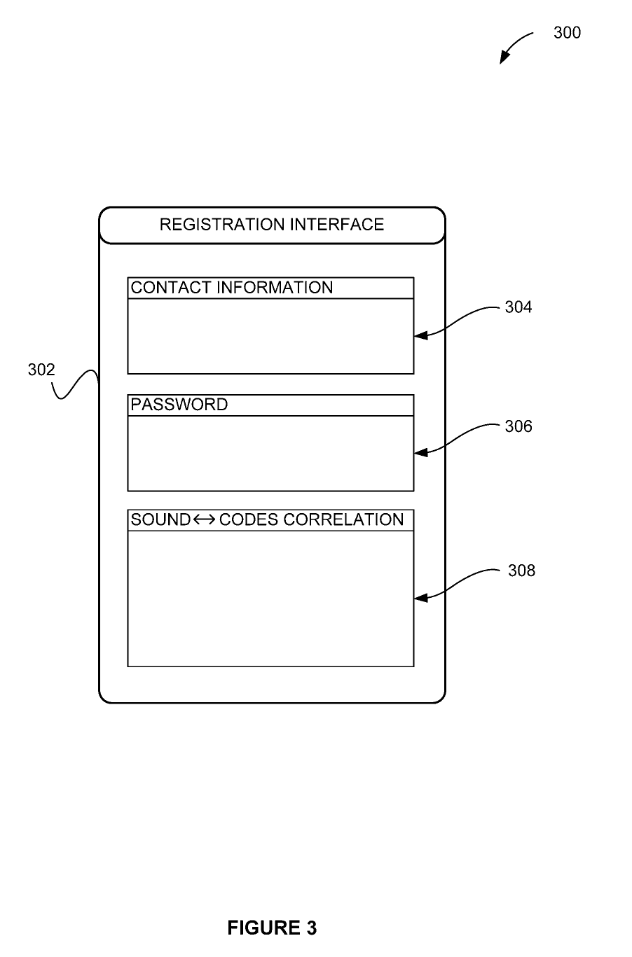

FIG. 3 illustrates a registration interface 300 in accordance with one embodiment. As an option, the registration interface 300 may be implemented in the context of any one or more of the embodiments set forth in any previous and/or subsequent figure(s) and/or description thereof. For example, the registration interface 300 may be used to collect information from an owner of a mobile device for use in connection with the textual code-based perceptible output feature of FIGS. 1-2B. However, it is to be appreciated that the registration interface 300 may be implemented in the context of any desired environment.

In one embodiment, the registration interface 300 may be accessed in response to a selection of a corresponding application icon on a home screen of a mobile device. In another embodiment, the registration interface 300 may be accessed in response to logging into an account via the Internet (possibly without necessarily using the mobile device). Further, as shown, a contact information field 304, a password field 306, and sound-code correlation field 308 are all included as components of the registration interface 300. While the various fields are shown to be simultaneously displayed on the registration interface 300, it should be noted that other embodiments are contemplated where these and/or other fields are accessed via various menus and/or workflows, as desired. Further, this data may be stored on the mobile device itself and, in some embodiments, a remote device may save such data on the mobile device.

In use, the contact information field 304 may be used to receive contact information of the owner of the mobile device. For example, such contact information may include an email and/or other address for use in communicating with another device.

Further, the password field 306 may be used to receive password information from the owner of the mobile device. In use, the password information may be used by the owner to securely access the registration interface 300, and/or the textual code-based perceptible output feature of FIGS. 1-2B. Still yet, while not shown, such configurations may be accessed via the registration interface 300 for configuring various aspects of any other features disclosed herein.

With continuing reference to FIG. 3, the sound-code correlation field 308 may be used to enter one or more textual codes and even various perceptible outputs (e.g. by uploading/selecting corresponding files, etc.). Thus, using the sound-code correlation field 308, a data structure such as that set forth in Table 1 above, may be entered and stored for use in connection with the return phone mode of operation and/or the textual code-based perceptible output feature.

By this design, the owner of the mobile device may configure the mobile device to emit perceptible outputs based on preconfigured codes. In one possible use case, such codes may be sent to the mobile device when the device is lost, in order to facilitate location of the device. Further, as an option, such codes may be shared with other parties, so that such other parties may communicate with the owner of the mobile device, using the codes. For example, the owner and such third parties may agree that one particular sound has a first meaning (e.g. call me when you have time, etc.), another particular sound has a second meaning (e.g. dinner is ready, etc.), etc.; thus providing a convenient/efficient/more secure way of communicating.

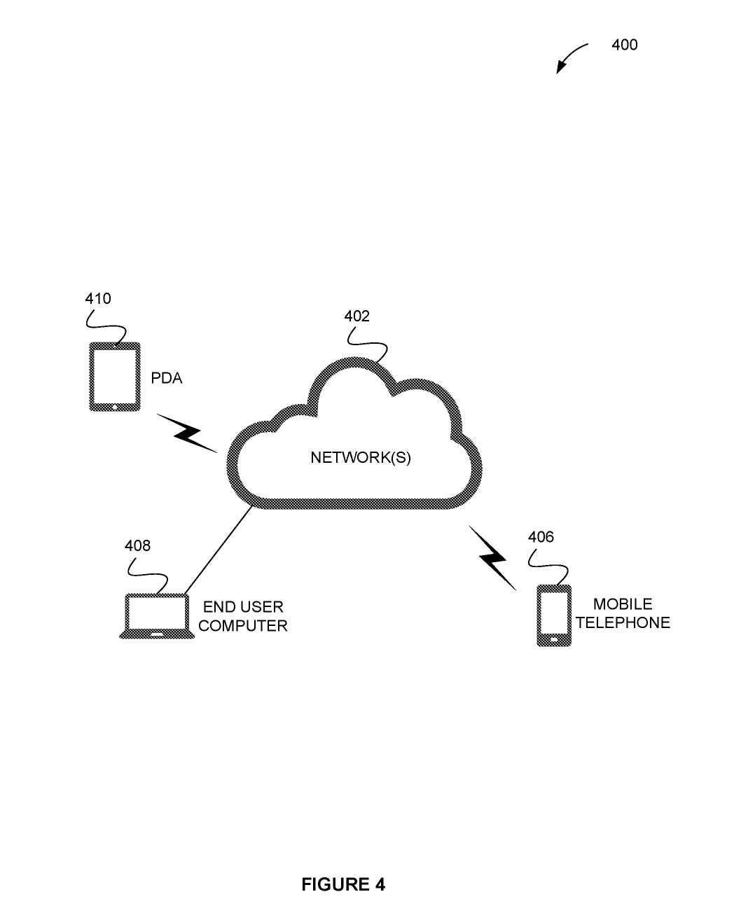

FIG. 4 illustrates a network architecture 400 including various mobile devices, in accordance with one embodiment. As shown, at least one network 402 is provided. In various embodiments, any one or more components/features set forth during the description of any previous figure(s) may be implemented in connection with any one or more of the mobile devices of the at least one network 402.

In the context of the present network architecture 400, the network 402 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 402 may be provided.

Coupled to the network 402 is a plurality of mobile devices. For example, an end user computer 408 may be coupled to the network 402 for communication purposes. Such end user computer 408 may include a lap-top computer, a notebook computer, and/or any other type of mobile computer. Still yet, various other devices may be coupled to the network 402 including a personal digital assistant (PDA) device 410, a mobile phone device 406, etc. Each of the devices 406, 408, and 410 can communicate with the network 402, and therefore with each other. The end user computer 408 can send textual code configurations and information to the mobile phone 406 and/or the PDA 410. When the mobile phone 406 or PDA 410 cannot be found, for example, the owner of the device (or other persons) can remotely send one or more textual codes to the device, triggering the generation of the at least one perceptible output to assist in locating the device. However, it should be understood that other uses of the textual code and perceptible output are contemplated and are within the scope of the description and claims.

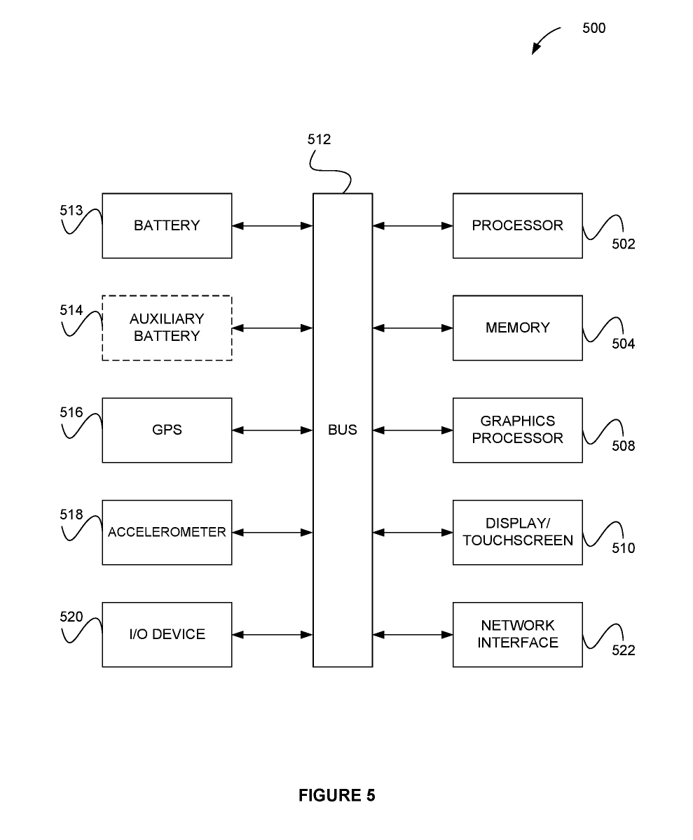

FIG. 5 illustrates an exemplary mobile device system 500, in accordance with one embodiment. As an option, the system 500 may be implemented in the context of any of the devices of the network architecture 400 of FIG. 4. However, it is to be appreciated that the system 500 may be implemented in any desired environment.

As shown, a mobile device system 500 is provided, including at least one processor 502 which is connected to a bus 512. The mobile device system 500 also includes memory 504 [e.g., a solid state drive, random access memory (RAM), etc.]. The memory 504 comprises one or more memory components, and may include different types of memory. The mobile device system 500 includes a display 510 in the form of a touchscreen or the like. The mobile device system 500 may include a graphics processor 508 coupled to the display 510.

Also included is a primary battery 513 for providing the various other illustrated components with power during regular use. Strictly as an option, such battery 513 may or may not be supplemented with an auxiliary battery 514. As mentioned earlier, such auxiliary battery 514 may be of a lesser size and/or capacity, as compared to the primary battery 513. The auxiliary battery 514 in some embodiments is regulated to provide electrical power for the receipt and use of textual codes in any of the embodiments discussed herein.

The mobile device system 500 is further shown to include a global positioning system (GPS) component 516 for providing location information in connection with the mobile device system 500. Still yet, an accelerometer 518 is provided for providing movement information in connection with the mobile device system 500. Even still yet, one or more I/O devices 520 are provided. In various embodiments, such I/O devices 520 may include an auditory output device (e.g. speaker, etc.), a tactile output device (e.g. vibrator mechanism, etc.), a visual output device (e.g. a flashlight, etc.), and/or any other output device capable of emitting perceptible output. In some embodiments, the one or more I/O devices 520 can further include input devices, including keyboards or keypads, soft keys, buttons, pointing devices, a microphone, etc. In various embodiments, the I/O devices 520 may be communicatively coupled to the bus 512 via hardwiring, and/or the I/O devices 520 may communicate with the other components via a wireless connection. Also shown communicatively coupled to the bus is a network interface 522 (e.g. modem, etc.) for communicating with one or more networks (e.g. the network 402 of FIG. 4, etc.) via one or more communication protocols (e.g. cellular, WiFi, BLUETOOTH, etc.).

Computer programs, or computer control logic algorithms, may be stored in the memory 504 and/or any other memory, for that matter. Such computer programs, when executed, enable the mobile device system 500 to perform various functions (as set forth above, for example). Memory 504 and/or any other storage comprise non-transitory computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), or the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; or the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

1. A method implemented by a mobile device comprising:
receiving a text message comprising a first code from a second device;
determining that the first code matches a second code stored on the mobile device; and
based on the determination:
receiving a file from the second device wherein the file comprises a representation of at least one output; and
generating the at least one output utilizing the received file.

2. The method of claim 1, wherein the at least one output comprises a tactile output generated by a tactile output device of the mobile device.

3. The method of claim 1, wherein the at least one output comprises an audible output generated by an auditory output device of the mobile device.

4. The method of claim 1, wherein the at least one output comprises a visual output generated by a visual output device of the mobile device.

5. (canceled)

6. The method of claim 1, further comprising:
receiving, by the mobile device, user input specifying the second code; and
storing, by the mobile device, the second code on the mobile device.

7. (canceled)

8. The method of claim 1, further comprising:
receiving, by the mobile device, user input; and
ceasing, by the mobile device, the generation of the at least one output based on receipt of the user input.

9. The method of claim 1, further comprising:
detecting, by the mobile device, a power supply level of a power supply of the mobile device;
determining, by the mobile device, whether the power supply level is below a threshold; and
allocating, by the mobile device, use of the power supply to at least one aspect of the generation of the at least one output if the power supply level of the mobile device is below the threshold.

10. The method of claim 1, further comprising:
detecting, by the mobile device, a power supply level of a power supply of the mobile device;
determining, by the mobile device, whether the power supply level is below a threshold; and
utilizing, by the mobile device, an auxiliary power source for at least one aspect of the generation of the at least one output if the power supply level of the mobile device is below the threshold.

11-12. (canceled)

13. A mobile device comprising:
a memory storing instructions; and
one or more processors in communication with the memory wherein the one or more processors execute the instructions to:
receive a text message comprising a first code from a second device;
determine that the first code matches a second code stored in the memory; and
based on the determination:
receive a file from the second device wherein the file comprises a representation of at least one output; and
generate the at least one output utilizing the file.

14. The mobile device of claim 13, wherein the at least one output comprises a tactile output generated by a tactile output device of the mobile device.

15. The mobile device of claim 13, wherein the at least one output comprises an audible output generated by an auditory output device of the mobile device.

16. The mobile device of claim 13, wherein the at least one output comprises a visual output generated by a visual output device of the mobile device.

17. (canceled)

18. The mobile device of claim 13, wherein the one or more processors execute the instructions to:
receive user input specifying the second code; and
store the second code on the mobile device.

19. (canceled)

20. The mobile device of claim 13, wherein the one or more processors execute the instructions to:
receive user input; and
cease the generation of the at least one output based on receipt of the user input.

21. The mobile device of claim 13, wherein the one or more processors execute the instruction to:
detect a power supply level of a power supply of the mobile device;
determine whether the power supply level is below a threshold; and
allocate use of the power supply to at least one aspect of the generation of the at least one output if the power supply level of the mobile device is below the threshold.

22. The mobile device of claim 13, wherein the one or more processors execute the instructions to:
detect a power supply level of a power supply of the mobile device;
determine whether the power supply level is below a threshold; and
utilize an auxiliary power source for at least one aspect of the generation of the at least one output if the power supply level of the mobile device is below the threshold.

23-24. (canceled)

25. A non-transitory computer-readable media storing computer instructions, that when executed by one or more processors of a mobile device, cause the one or more processors to:
receive a text message comprising a first code from a second device;
determine that the first code matches a second code stored on the mobile device; and
based on the determination:
receive a file from the second device wherein the file comprises a representation of at least one output; and
generate the at least one output utilizing the file.
